(19) United States
(12) Patent Application Publication
(10) Pub. No.: US 2015/0339611 A1
(43) Pub. Date: Nov. 26, 2015

(54) MINIMIZING UNDESIRABLE USER RESPONSES IN AUTOMATED BUSINESS PROCESSES

(71) Applicant: International Business Machines Corporation, Armonk, NY (US)

(72) Inventors: Donna K. Byron, Petersham, MA (US); Duke Chang, Hillsborough, NC (US); Alexander Pikovsky, Laxington, MA (US); Timothy Winkler, Clinton, MA (US)

(73) Assignee: International Business Machines Corporation, Armonk, NY (US)

(21) Appl. No.: 14/283,643

(22) Filed: May 21, 2014

(51) Int. Cl. G06Q 10/06; H04L 29/06

(52) U.S. Cl. CPC G06Q 10/06316; H04L 67/42

(57) ABSTRACT

A system, and computer program product for minimizing undesirable user responses in automated business processes design are provided in the illustrative embodiments. A user response is identified in an interaction between a user and an automated business process. Using sentiment analysis, a determination is made that the user response comprises an undesirable response based on an undesirable emotional state of the user. A modification is selected, wherein the modification causes a change in the interaction to minimize the undesirable response. The modification is applied to the automated business process to cause the change in a future portion of the interaction.

### TECHNICAL FIELD

The present invention relates generally to a method, system, and computer program product for improving customer satisfaction. More particularly, the present invention relates to a method, system, and computer program product for minimizing undesirable user responses in automated business processes.

### BACKGROUND

Businesses often lose customers who are upset due to an automated process which results in an action that is unfair to the customer (generally, a user). For example a business process in a business enterprise may assess a fee to a user's account due to an honest misunderstanding by the user.

As another example, a user may be frustrated by having to traverse an extensive automated telephone menu each time the user calls the same enterprise in furtherance of resolving an ongoing issue. Because of actual or perceived unfair treatment by the enterprise, an upset or frustrated user often exits the relationship with the business enterprise.

Some business enterprises attempt to save these users by involving a human actor in the interaction, who reverses the fees, addresses the user's complaint, or otherwise appeases the user. Many enterprises factor the user-attrition as a cost of doing business, and continue business as usual, leaving the offending business processes unchanged.

### SUMMARY

The illustrative embodiments provide a method, system, and computer program product for minimizing undesirable user responses in automated business processes. An embodiment includes a method for minimizing undesirable user responses in automated business processes. The embodiment identifies, using a processor and a memory, a user response in an interaction between a user and an automated business process. The embodiment determines, using sentiment analysis, that the user response comprises an undesirable response based on an undesirable emotional state of the user. The embodiment selects a modification, wherein the modification causes a change in the interaction to minimize the undesirable response. The embodiment applies the modification to the automated business process to cause the change in a future portion of the interaction.

Another embodiment includes a computer usable program product comprising a computer usable storage device including computer usable code for minimizing undesirable user responses in automated business processes. The embodiment further includes computer usable code for identifying, using a processor and a memory, a user response in an interaction between a user and an automated business process. The embodiment further includes computer usable code for determining, using sentiment analysis, that the user response comprises an undesirable response based on an undesirable emotional state of the user. The embodiment further includes computer usable code for selecting a modification, wherein the modification causes a change in the interaction to minimize the undesirable response. The embodiment further includes computer usable code for applying the modification to the automated business process to cause the change in a future portion of the interaction.

Another embodiment includes a data processing system for minimizing undesirable user responses in automated business processes. The embodiment further includes a storage device including a storage medium, wherein the storage device stores computer usable program code. The embodiment further includes a processor, wherein the processor executes the computer usable program code. The embodiment further includes computer usable code for identifying, using a processor and a memory, a user response in an interaction between a user and an automated business process. The embodiment further includes computer usable code for determining, using sentiment analysis, that the user response comprises an undesirable response based on an undesirable emotional state of the user. The embodiment further includes computer usable code for selecting a modification, wherein the modification causes a change in the interaction to minimize the undesirable response. The embodiment further includes computer usable code for applying the modification to the automated business process to cause the change in a future portion of the interaction.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a configuration for minimizing undesirable user responses in automated business processes in accordance with an illustrative embodiment;

FIG. 4 depicts an example process for minimizing undesirable user responses in automated business processes in accordance with an illustrative embodiment; and

FIG. 5 depicts a flowchart of an example process for creating a heuristic for minimizing undesirable user responses in automated business processes in accordance with an illustrative embodiment.

### DETAILED DESCRIPTION

A user engages in a variety of interactions with a business enterprise. These interactions include making inquiries, trading of goods or services, account management, making suggestions or complaints, disputing or confirming an action, and many other types of interactions. These and other types of interactions between a user and a business enterprise are collectively referred to herein as transactions.

The illustrative embodiments recognize that the experience of a user in a transaction with a business enterprise and the response of the user to that experience are often significant determinative factors in continued relationship between the user and the business enterprise. The illustrative embodiments recognize that user experience in a business transaction can be improved if an adverse or undesirable user response can be averted, preempted, or otherwise avoided. The illustrative embodiments further recognize that an undesirable response by a user is predictable, and therefore avoidable in many situations.

The illustrative embodiments used to describe the invention generally address and solve the above-described problems and other problems related to improving the customer experience in transactions with business enterprises. The illustrative embodiments provide a method, system, and computer program product for minimizing undesirable user responses in automated business processes.

Data of the user's experience and response in a previous transaction is often available in customer service logs, letters, emails, and voice messages from the users. An embodiment constructs a corpus of documents by collecting textual data when available, and converting speech to text as needed. The embodiment applies any suitable known sentiment analysis technique on the corpus or a portion thereof to identify instances of specific sentiments likely experienced by the user.

An embodiment correlates a transaction, a workflow, or a timeline at the time of the user experiencing certain undesirable sentiments, e.g., anger, dissatisfaction, annoyance, irritability, impatience, frustration, threat, and the like. A workflow comprises a sequence of steps in a process, and a timeline comprises a sequence of events in time as they occur.

One embodiment notates a record associated with a user when an undesirable response is correlated with a transaction workflow, or timeline. In a future similar transaction, workflow, or timeline, if a state is reached from where a similar undesirable response is likely according to the notation, the embodiment takes corrective actions. For example, one example embodiment modifies a workflow such that a step where the undesirable response occurred in the past can be avoided or replaced.

Another example embodiment modifies a business process such that the transaction or timeline can be altered from that state such that a step where the undesirable response occurred in the past can be avoided or replaced. Another example embodiment transitions from an automated business process to a human-facilitated business process to provide a better or different experience to the user and avoid the undesirable response.

Another embodiment considers the corpora comprising corpus documents from several users. The embodiment normalizes the corpora to disregard personal identifying information, unique user traits or circumstances contributing one-off type undesirable responses, or a combination thereof. The embodiment correlates various undesirable user responses with corresponding transactions, workflows, or timelines. The embodiment determines whether certain undesirable responses correspond to the same or similar transactions, workflows, or timelines in a similar manner more than a threshold number of times.

When the embodiment discovers a transaction, workflow, or a timeline, or a portion thereof, which causes undesirable responses in users more than the threshold number of times, one embodiment modifies or causes to be modified the transaction, the workflow, the timeline, a business process related thereto. The embodiment selects and applies or causes to be applied one or more modifications for this purpose, such that undesirable responses in that transaction, workflow, or timeline can be avoided or at least reduced below the threshold.

Another embodiment develops one or more heuristics based on the analyses of normalized corpora in this manner. A heuristic allows an embodiment to identify a condition or a state in a transaction from where an undesirable response is likely. A heuristic developed for this purpose can take the form of a rule or logic, constructed from observations in the historical data of the normalized corpora. As a simple example, one example heuristic may be logic that recognizes a repeat caller, identifies an open issue relative to the caller, and allows the caller to bypass an automated information collection menu. Another example heuristic allows such callers to be given priority amongst other callers.

Another example heuristic may be a rule for allying late payment penalties to a user's account. For example, the heuristic recognizes that a user has timely paid previous bills over some period, and upon detecting a missing payment pauses an accounting process that would cause a late fee to be assessed on a new bill. The heuristic flags the user account for reconsideration citing a high probability that the missing payment will likely be received within a certain period or may already have been processed. Furthermore, the heuristic, in combination with another heuristic, causes a different business process to engage, such as to postpone the delivery of a bill until all currently received payments have been processed, or holding the bill until a human actor can make a determination of further actions.

The illustrative embodiments are described with respect to certain sentiments, transactions, states, conditions, heuristics, actions, modifications, rules, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

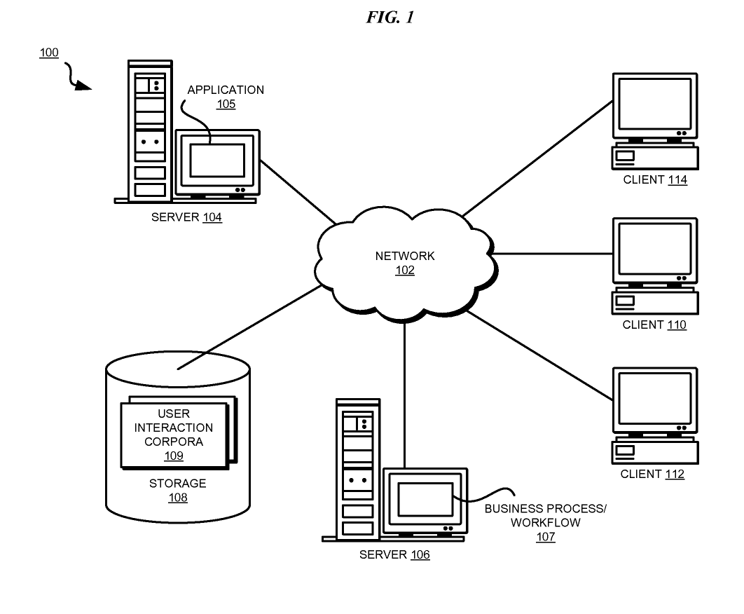

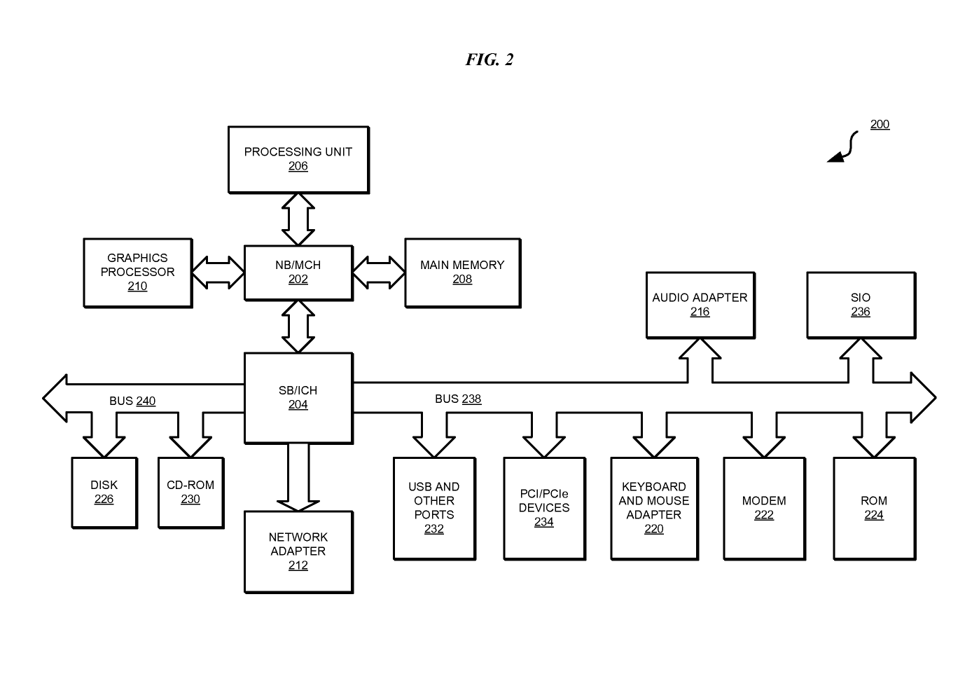

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of data processing systems in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any data processing system or device in data processing environment 100. Clients 110, 112, and 114 also couple to network 102. A data processing system, such as server 104 or 106, or client 110, 112, or 114 may contain data and may have software applications or software tools executing thereon.

In addition, device 132 may be a data processing system in the form of a mobile device. Device 132 is able to communicate with network 102 using wireless communication 120.

Only as an example, and without implying any limitation to such architecture, FIG. 1 depicts certain components that are usable in an example implementation of an embodiment. Servers 104 and 106, and clients 110, 112, 114, are depicted as servers and clients only as example. Data processing systems 104, 106, 110, 112, and 114 also represent example nodes in a cluster, partitions, and other configurations suitable for implementing an embodiment. Server 104 includes application 105, which includes an embodiment described herein. Any data processing system in data processing environment 100, e.g., server 106, implements a business process or workflow used in a transaction. Corpora 109 in storage 108 comprises corpus of user interaction information about one or more users. As an example, a corpus in corpora 109 can include, but is not limited to, textual description of user's comments, emotions, tone, or language during a written or verbal conversation, comments communicated by a user to a business enterprise in textual or verbal form, data logged by a system, application, or process during an interaction with a user, and so on. Data logged during an interaction can include, but is not limited to, textual entries, verbal entries, pointer movements, gestures, pointer focus shifts, time period between interactions, frequency of visit or use (of a system or application), history of a subject of an interaction, and other suitable implementation-specific information.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

Servers 104 and 106, storage unit 108, and clients 110, 112, and 114 may couple to network 102 using wired connections, wireless communication protocols, or other suitable data connectivity. For example, a cluster typically has multiple network types, such as IP networks, direct connections of machines via packets exchange implemented by storage protocols (Fibre Channel, SCSI), serial links, and message exchange via writing and reading packets to shared storage such as a hard disk drive. For performance reasons, in sending client traffic, an IP network is given precedence. Furthermore, a given network type may not connect to all nodes in a cluster. For instance, a cluster may span machines located at two geographically distant sites. For the long distance connection, Ethernet may be the preferred connection, and within a geographical location, a direct connection may be preferable. Additionally, within a geographical location, additional non-IP networks, such as Fibre channel or serial connections may be used within the scope of the illustrative embodiments.

Clients 110, 112, and 114 may be, for example, personal computers, network computers, thin clients, or industrial control systems. In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another, and encompasses components including but not limited to IP and SAN components. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), a wide area network (WAN), or mobile ad hoc network (MANET). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104, server 106, or client 112 in FIG. 1, or another type of device in which computer usable program code or instructions implementing the processes of the illustrative embodiments may be located for the illustrative embodiments. Data processing system 200 is also representative of a device, such as device 132 in FIG. 1 in which computer usable program code or instructions implementing the processes of the illustrative embodiments may be located for the illustrative embodiments. Data processing system 200 is described as a computer only as an example, without being limited thereto. Implementations in the form of device 132 in FIG. 1 may modify data processing system 200 and even eliminate certain depicted components there from without departing from the general description of the operations and functions of data processing system 200 described herein.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may include one or more processors and may be implemented using one or more heterogeneous processor systems. Graphics processor 210 may be coupled to NB/MCH 202 through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204 through bus 238.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Program instructions for the operating system, the object-oriented programming system, the processes of the illustrative embodiments, and applications or programs, including applications 105, 133, and 113 in FIG. 1, are each located on one or more storage devices, such as hard disk drive 226 or CD-ROM 230, and may be loaded into at least one of one or more memories, such as main memory 208, read only memory 224, or one or more peripheral devices, for execution by processing unit 206. Program instructions may also be stored permanently in non-volatile memory and either loaded from there or executed in place. For example, a program code according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA) or another mobile computing device, which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

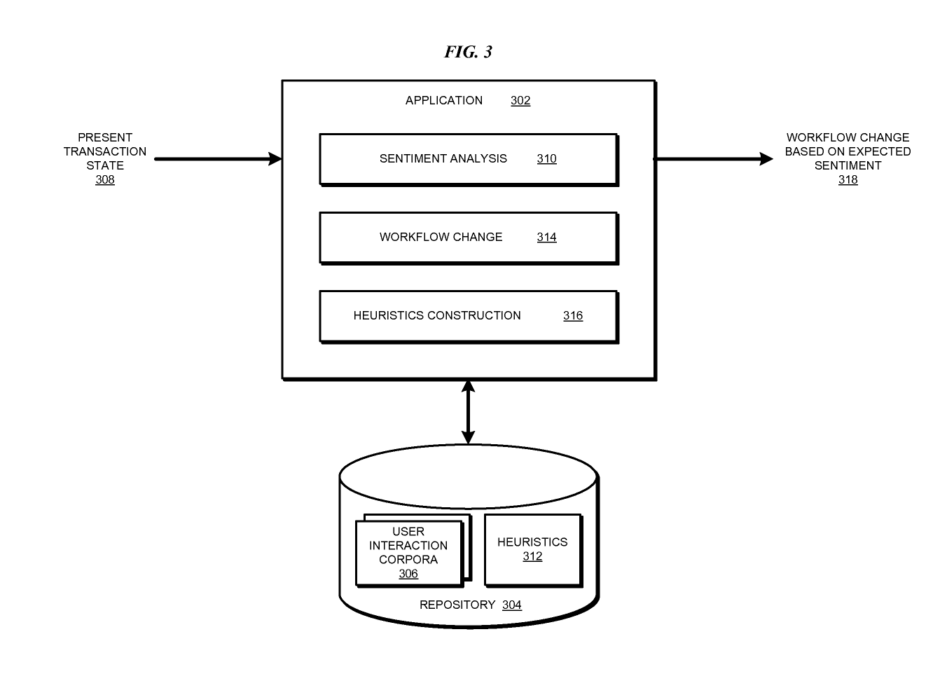

With reference to FIG. 3, this figure depicts a block diagram of a configuration for minimizing undesirable user responses in automated business processes in accordance with an illustrative embodiment. Application 302 is an example embodiment of application 105 in FIG. 1. Repository 304 and user interaction corpora 306 therein are examples of storage 108 and corpora 109, respectively, in FIG. 1.

Application 302 receives transaction state information 308. In one embodiment, transaction state information 308 is information pertaining to a state in a presently occurring transaction with a user. In another embodiment, transaction state information 308 is information pertaining to a state in a future transaction may be with a user.

Component 310 performs sentiment analysis using any known sentiment analysis technique. In one embodiment, component 310 performs sentiment analysis on information 308 of a transaction. In another embodiment, component 310 performs sentiment analysis on information 308 of a transaction in combination with a corpus of the user in information 308. In another embodiment, component 310 performs sentiment analysis on information 308 of a transaction in combination with a notation in the user's record (not shown) based on past experiences. In another embodiment, component 310 performs sentiment analysis on information 308 of a transaction in combination with one or more of a corpus of the user in information 308 and a heuristic in heuristics 312 in repository 304.

Component 314 identifies a change in a transaction, workflow, timeline, or a process. The change identified by component 314 is based on an undesirable sentiment currently being experienced or likely to be experienced by a user, e.g., the user in information 308. The change identified by component 314 is selected or configured to minimize or avoid the undesirable sentiment.

In one embodiment, the change identified by component 314 modifies the transaction of information 308. In another embodiment, the change modifies a workflow or a business process of the transaction of information 308. In another embodiment, the change modifies a timeline of a future portion of the transaction of information 308. In another embodiment, the change applies to the user in information 308. In another embodiment, the change applies to more than one users of a business process. In one embodiment, the change causes another system to perform these and other similar actions.

Component 316 constructs a heuristic for detecting an undesirable sentiment, changing a workflow or business process, or a combination thereof. For example, in one embodiment, component 316 uses corpora 306 to construct a heuristic for identifying a transaction or a portion thereof where several users experience an undesirable sentiment. In another example embodiment, component 316 uses corpora 306 to construct a heuristic for modifying a transaction for a single user, e.g., the user in information 308. In another example embodiment, component 316 uses corpora 306 to construct a heuristic for modifying a transaction for several users. In another example embodiment, component 316 constructs a heuristic for modifying a presently occurring transaction. In another example embodiment, component 316 constructs a heuristic for modifying a future transaction.

Application outputs change 318. In one embodiment, change 318 applies to the transaction in information 308. In another embodiment, change 318 applies to a future transaction. In another embodiment, change 318 applies to a business process or workflow. In another embodiment, change 318 causes another system or application to apply the change to a transaction, workflow, timeline, or business process.

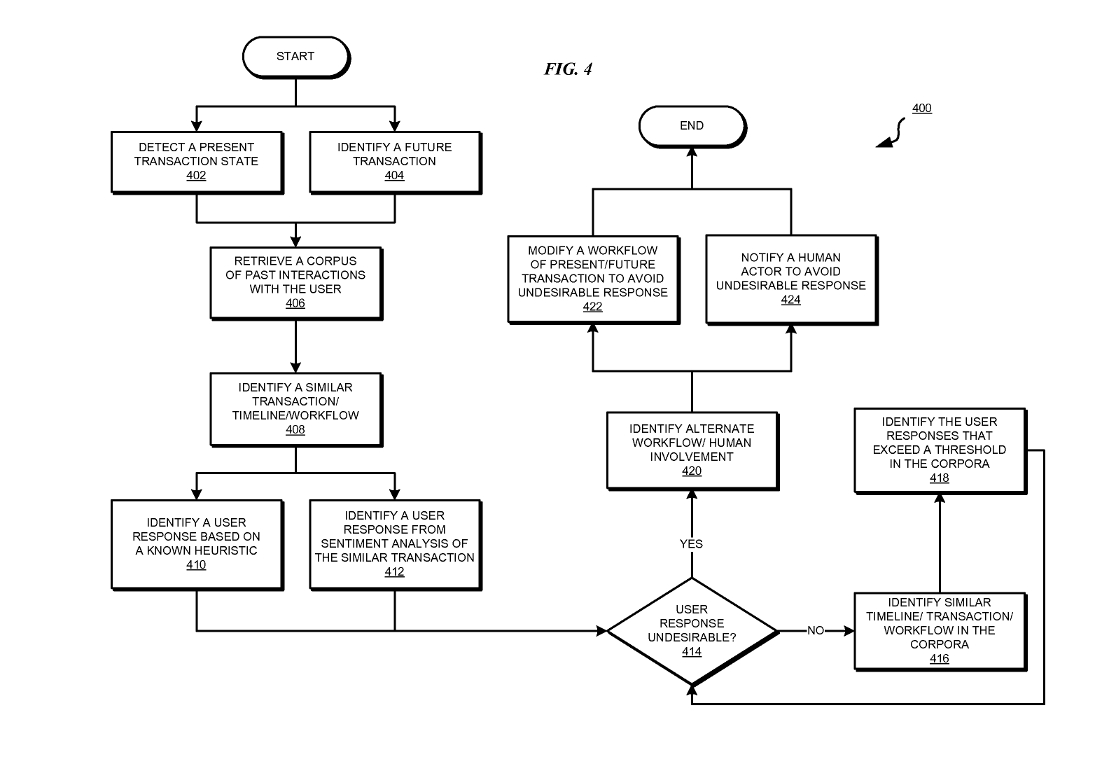

With reference to FIG. 4, this figure depicts an example process for minimizing undesirable user responses in automated business processes in accordance with an illustrative embodiment. Process 400 can be implemented in application 302 in FIG. 3.

The application detects a state in a present transaction (block 402). Alternatively or together with block 402, the application identifies a state in a transaction that would occur in the future (block 404). Furthermore, the state is of the transaction involving a particular user.

The application retrieves a corpus of past interactions with the user (block 406). The application identifies a similar transaction, timeline, or workflow that occurred in the past with the user according to the corpus (block 408).

The application identifies a user response based on a known heuristic (block 410). Alternatively or together with block 410, the application identifies a user response from a sentiment analysis of the similar transaction identified in block 408 (block 412). In one embodiment, the sentiment analysis is performed on-demand as a transaction is progressing. In another embodiment, the sentiment analysis is performed offline, e.g., using data saved in the user's corpus.

The application determines whether the user response is undesirable (block 414). If the user response is not undesirable (“No” path of block 414), the application may end process 400 thereafter, or optionally identify similar transactions, timelines, or workflows in the corpora of several users (block 416). The application identifies the user responses that exceed a threshold for those similar transactions, timelines, or workflows (block 418). The application then returns to block 414 and determines whether the threshold amount of user responses of several users to those similar transactions, timelines, or workflows are undesirable.

If the user response is undesirable (“Yes” path of block 414), the application identifies a change in the transaction, timeline, workflow, or business process (block 420). In one embodiment, the change comprises replacing the entire transaction, workflow, or business process, or a portion thereof with a different compatible transaction, workflow, or business process. In another embodiment, the change comprises identifying a human action and involving a human actor, e.g., by notifying a human actor. Involving a human actor and identifying a change are not mutually exclusive, and both actions are contemplated in certain circumstances.

The application modifies, or causes to be modified, the transaction, timeline, workflow, or business process, or a combination thereof according to the change identified in block 420 to avoid or mitigate the undesirable response (block 422). Where the change comprises involving a human actor, the application notifies a human actor to avoid or mitigate the undesirable response (block 424). The application ends process 400 thereafter.

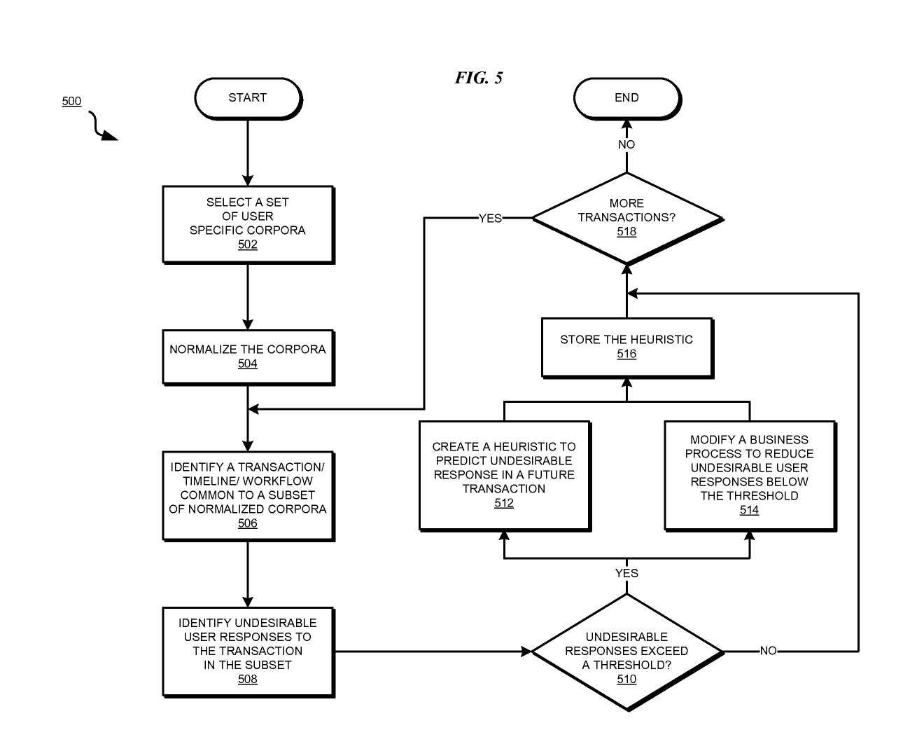

With reference to FIG. 5, this figure depicts a flowchart of an example process for creating a heuristic for minimizing undesirable user responses in automated business processes in accordance with an illustrative embodiment. Process 500 can be implemented in application 302 in FIG. 3.

The application selects a set of user-specific corpora, e.g., from corpora 306 in FIG. 3 (block 502). The application normalizes the selected corpora, e.g., to remove identifying information, aberrant occurrences of troubles or undesirable user responses, extraordinary circumstances, and the like (block 504). In some instances, the normalization may not be necessary and block 504 may be omitted.

The application identifies a transaction, timeline, workflow, or a business process common to a subset of the selected, and optionally normalized, corpora (block 506). The application identifies the undesirable user responses it the transactions in the subset (block 508).

The application determines whether the total quantity, duration, number, or amount of undesirable user responses exceed a threshold (block 510). If not, (“No” path of block 510), the application proceeds to block 518 in process 500. If the undesirable user responses exceed the threshold (“Yes” path of block 510), the application creates a heuristic to predict an undesirable response in a future transaction (block 512). Alternatively or in combination with block 512, the application creates a heuristic to modify, or cause to be modified, a business process or a workflow to reduce the undesirable user response to a level below the threshold (block 514).

The actual prediction of the undesirable response is an operation that can be performed in application 302 using any sentiment analysis technique under the control of the heuristic of block 512. Similarly, the actual modification of a business process or workflow can be performed or caused to be performed by application 302 under the control of the heuristic of block 514 and depending on the implementation of the particular business process or workflow in question.

The application stores the heuristic, e.g., in repository 304 in FIG. 3 (block 516). The application determines whether more transactions have to be analyzed for undesirable user responses in this manner (block 518). If so, (“Yes” path of block 518), the application returns process 500 to block 506. Otherwise (“No” path of block 518), the application ends process 500 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for minimizing undesirable user responses in automated business processes.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1-10. (canceled)

11. A computer usable program product comprising a computer usable storage device including computer usable code for minimizing undesirable user responses in automated business processes, the computer usable code comprising:
computer usable code for identifying, using a processor and a memory, a user response in an interaction between a user and an automated business process;
computer usable code for determining, using sentiment analysis, that the user response comprises an undesirable response based on an undesirable emotional state of the user;
computer usable code for selecting a modification, wherein the modification causes a change in the interaction to minimize the undesirable response; and
computer usable code for applying the modification to the automated business process to cause the change in a future portion of the interaction.

12. The computer usable program product of claim 11, wherein the computer usable code for minimizing the undesirable response comprises computer usable code for minimizing an effect of the undesirable response on a business objective of the automated business process.

13. The computer usable program product of claim 11, further comprising:
computer usable code for causing the modification in the automated business process such that a future user response in a future interaction between a second user and the automated business process is not of a type of the undesirable response.

14. The computer usable program product of claim 11, wherein the modification in the future portion comprises including a human actor in the future portion.

15. The computer usable program product of claim 11, wherein the interaction is at a first state at a time of the identifying the user response, and wherein the user response is likely to occur at a second state in the future portion of the interaction.

16. The computer usable program product of claim 15, wherein the computer usable code for applying causes a workflow change such that the second state is modified to a third state in the future portion.

17. The computer usable program product of claim 11, wherein the interaction is part of a corpus stored in a repository, and wherein the corpus comprises a combination of textual data, verbal communication data, and system interaction data.

18. The computer usable program product of claim 11, wherein the computer usable code is stored in a computer readable storage medium in a data processing system, and wherein the computer usable code is transferred over a network from a remote data processing system.

19. The computer usable program product of claim 11, wherein the computer usable code is stored in a computer readable storage medium in a server data processing system, and wherein the computer usable code is downloaded over a network to a remote data processing system for use in a computer readable storage medium associated with the remote data processing system.

20. A data processing system for minimizing undesirable user responses in automated business processes, the data processing system comprising:
a storage device including a storage medium, wherein the storage device stores computer usable program code; and
a processor, wherein the processor executes the computer usable program code, and wherein the computer usable program code comprises:
computer usable code for identifying, using a processor and a memory, a user response in an interaction between a user and an automated business process;
computer usable code for determining, using sentiment analysis, that the user response comprises an undesirable response based on an undesirable emotional state of the user;
computer usable code for selecting a modification, wherein the modification causes a change in the interaction to minimize the undesirable response; and
computer usable code for applying the modification to the automated business process to cause the change in a future portion of the interaction.
